(19) United States
(12) Patent Application Publication
(10) Pub. No.: US 2007/0097810 A1
(43) Pub. Date: May 3, 2007

(54) OPTICAL HEAD UNIT AND OPTICAL DISC APPARATUS

(76) Inventors: Kazuhiro Nagata, Yokohama-shi (JP); Katsuo Iwata, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/553,795

(22) Filed: Oct. 27, 2006

(30) Foreign Application Priority Data
Oct. 31, 2005 (JP) 2005-317630

(51) Int. Cl. G11B 7/00; G11B 7/135

(52) U.S. Cl. 369/44.23; 369/112.02

(57) ABSTRACT

According to one embodiment, an optical head unit which is provided with a liquid crystal element to correct aberration on an information recording surface of an optical disc, to decrease the influence of inclination and variations in the thickness of an optical disc, regardless of displacement of an optical axis of an object lens from a central axis of a liquid crystal element, the outermost transparent electrode among transparent electrodes optimized at a position where the optical axis of the object lens is not displaced from the center of the transparent electrode of the liquid crystal element, is shaped like an ellipse by extending in the radial direction of an optical disc.

### CROSS-REFERENCE TO RELATED APPLICATIONS

This application is based upon and claims the benefit of priority from Japanese Patent Application No. 2005-317630, filed Oct. 31, 2005, the entire contents of which are incorporated herein by reference.

### BACKGROUND

1. Field

One embodiment of the invention relates to improvement of an optical head and an optical disc apparatus.

2. Description of the Related Art

Optical discs with several kinds of recording density called CD and DVD have been widely used. Recently, a high definition (HD) DVD optical disc, which is recordable and reproducible by using a blue-purple laser beam and increased in the recording density, has been put to practical use.

An optical disc has at least a transparent substrate in a recording layer, and records or reads information in/from a recording layer by radiating a laser beam from the outside of the substrate.

Therefore, it is necessary to consider the influence of spherical aberration caused by variations in the distance between the recording layer and transparent substrate, that is, the thickness of the substrate thickness (individual difference), and aberration such as a coma aberration component caused by the inclination of an optical disc. DVD and HD DVD optical discs include an optical disc having two recording layers. Therefore, the distance from the outer surface of an optical disc to the recording layer is slightly different in the first and second layers. As a result, spherical aberration is generated as well known, in addition to the above-mentioned variations in the thickness of optical disc.

In the background described above, some types of optical disc apparatus use a liquid crystal element to correct the influence of spherical aberration and coma aberration components.

When using a liquid crystal element, it is necessary to consider displacement between the central axis of a liquid crystal element and the optical axis of an object lens. When the optical axis (an object lens) is displaced from the central axis (the liquid crystal element), correction to cancel the aberration components becomes insufficient.

When the liquid crystal element is integrally incorporated in an actuator together with an object lens, the liquid crystal element moves as one unit with the object lens. This is preferable for correction of spherical aberration without displacement of the optical axis (object lens) from the central axis (liquid crystal element), and/or without changes in the amount of displacement. However, as the weight of the liquid crystal element is added to a movable part of the actuator, the actuator size becomes large. Further, the wiring to the liquid crystal element is difficult.

When the liquid crystal element is provided independently of the actuator, the movable part of the actuator can be made small, and the wiring to the liquid crystal element is easy. However, it is impossible to completely eliminate eccentricity between the center of rotation of an optical disc and a track (guide groove) specific to an optical disc or a record mark string (recorded data). It is thus understandable that the optical axis (object lens) is displaced from the central axis (liquid crystal element) by moving the object lens in the disc radial direction to align a laser beam guided on the optical axis of the object lens with the center of the track or the string of record marks.

Japanese Patent No. 3594811 discloses an example of changing an electrode pattern of a liquid crystal element to compensate a spherical aberration component caused by the inclination of an optical head, to the recording surface of an optical disc, in a radial direction assuming the result that the optical axis (object lens) is displaced from the central axis (crystal liquid element), in a method of providing the above-mentioned liquid crystal in a fixed optical system.

However, as disclosed in the above Japanese Patent, changing the electrode pattern of a liquid crystal element previously adds compensation of aberration that is originally unnecessary for a laser beam, when the optical axis (object lens) is not displaced from the central axis (liquid crystal element) and/or when the amount of displacement does coincide with a predetermined amount.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A is an exemplary diagram showing an example of a formation of a transparent electrode of a liquid crystal display (LCD) for use in an optical head unit of an optical disc apparatus in accordance with an embodiment of the invention;

FIG. 1B is a graph showing an example of a correction phase by the LCD shown in FIG. 1A, according to an embodiment of the invention;

FIG. 2 is a graph showing an example of a relationship between the correction phase by the LCD shown in FIG. 1A and the wavefront aberration of an optical recording member, according to an embodiment of the invention (a graph explaining a relationship between a correction phase supplied by LCD and wavefront aberration of an optical recording medium);

FIG. 3 is a graph showing an example of wavefront aberration (correction result) using the correction phase shown in FIG. 2, according to an embodiment of the invention (a graph showing the state that wavefront aberration of an optical recording member is corrected by the correction phase shown in FIG. 2);

FIG. 4 is an exemplary diagram showing an example of a formation of an optical head unit using in an optical disc apparatus, according to an embodiment of the invention;

FIG. 5A is an exemplary diagram showing an example of a formation of a liquid crystal display (LCD) of the optical head unit shown in FIG. 4 of the optical disc apparatus, according to an embodiment of the invention; and

FIG. 5B is a graph showing an example of a correction phase by the LCD shown in FIG. 5A, according to an embodiment of the invention.

### DETAILED DESCRIPTION

Various embodiments according to the invention will be described hereinafter with reference to the accompanying drawings. In general, according to one embodiment of the invention, an optical head unit which is provided with a liquid crystal element to correct aberration on an information recording surface of an optical disc, to decrease the influence of inclination and variations in the thickness of an optical disc, regardless of displacement of an optical axis of an object lens from a central axis of a liquid crystal element, the outermost transparent electrode among transparent electrodes optimized at a position where the optical axis of the object lens is not displaced from the center of the transparent electrode of the liquid crystal element, is shaped like an ellipse by extending in the radial direction of an optical disc.

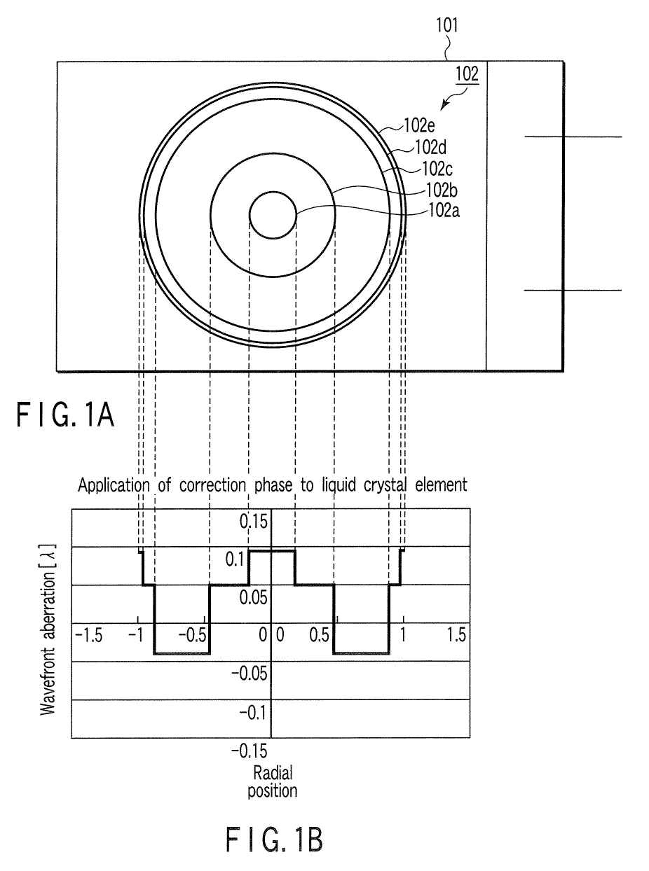

According to an embodiment, FIGS. 1A and 1B show an example of an information recording/reproducing apparatus (an optical disc apparatus).

An optical head which corrects aberration even if the optical axis of an object lens is displaced from a liquid crystal element, in a liquid crystal element to correct spherical aberration and coma aberration, and is not degraded in the correction even if the optical axis of an object lens is not displaced from the liquid crystal element, and an optical disc apparatus incorporated with the optical head.

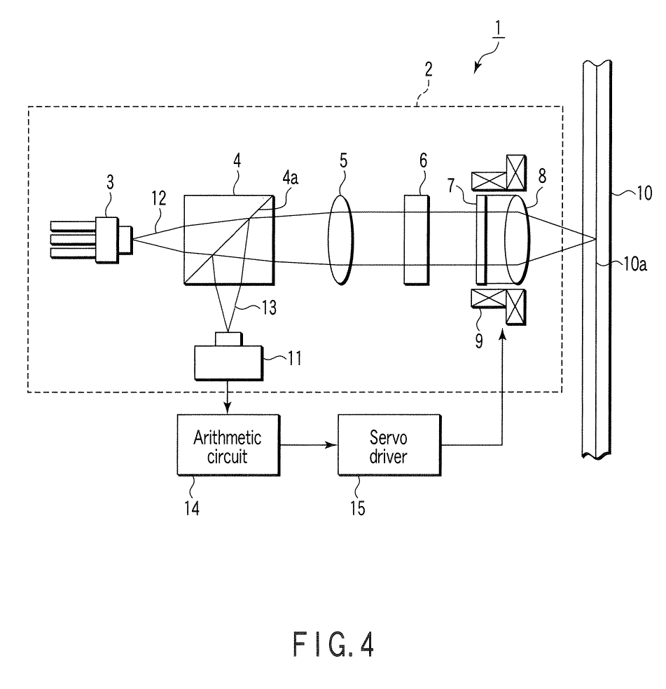

An optical disc apparatus 1 shown in FIG. 4 has an optical head 2. The optical head 2 includes a semiconductor laser element 3 to output a laser beam 12 with a predetermined wavelength. The wavelength of the laser beam 12 emitted from the semiconductor laser element 3 is 400 to 410 nm, preferably 405 nm.

The laser beam 12 from the semiconductor laser element 3 passes through a polarization beam splitter 4, and is collimated by a collimator lens 5, transmitted through a liquid crystal element 6, a λ/4 plate and a diffraction element 7, and condensed on a recording/reproducing surface 10a of an optical disc 10 through an object lens 8.

The laser beam 12 condensed on the recording/reproducing surface 10a of the optical disc 10 is reflected on the recording/reproducing surface 10a, returned to the object lens 8 as a reflected laser beam 13, and sent back to the polarization beam splitter 4 through the λ/4 plate, diffraction element 7, liquid crystal element 6 and collimator lens 5. The reflected laser beam 13 sent back to the polarization beam splitter 4 is reflected on the reflection surface 4a of the polarization beam splitter 4, and focused as an image on the light-receiving surface of a photodetector 11.

The light-receiving surface of the photodetector 11 is usually divided into a predetermined shape a predetermined number of areas, and outputs an electric current corresponding to the intensity of an optical beam received in each light-receiving area. The current output from each light-receiving area is converted into a voltage signal by a not-shown I/V (current-voltage) conversion amplifier, and processed by an arithmetic circuit 14 to be usable as an RF (reproducing) signal, a focus error signal and a track error signal. The RF signal is converted into a predetermined signal format, or through a predetermined interface, though not described in detail, and output to a temporary storage or an external memory.

The signal obtained from the arithmetic circuit 14 is supplied to a servo driver 15, and used to generate a focus error signal to change the position of the object lens 8, so that an optical spot formed in a predetermined size at the focal position of the object lens coincides with the distance between the object lens 8 and the recording/reproducing surface 10a of the optical disc 10. The focus error signal is used to obtain a focus control signal to change the position of the object lens 8 with respect to the actuator 9 which changes the position of the object lens 8. The focus control signal generated based on the focus error signal is supplied to the actuator 9. The object lens 8 held by the actuator 9 is optionally moved in the direction approaching to or separating from the recording/reproducing surface 10a of the optical disk 10 (in the left/right direction in FIG. 1).

The signal obtained by the arithmetic circuit 14 is supplied also to the servo driver 15, and used to generate a tracking error signal to change the position of the object lens 8, so that the optical spot of the laser beam 14 condensed at the focal position of the object lens 8 is guided to substantially the center of a record mark string recorded on the recording/reproducing surface 10a of the optical disk 10 or a previously formed guide groove or track.

The tracking signal is used to obtain a tracking control signal to change the position of the object lens 8 to a predetermined position with respect to the actuator 9 which changes the position of the object lens 8, and the tracking control signal generated based on the tracking error signal is supplied to the actuator 9. Therefore, the object lens 8 held by the actuator 9 is optionally moved in the radial direction of the recording/reproducing surface 10a of the optical disc 10, or in the direction crossing the track or the string of record marks.

Namely, the object lens 8 is sequentially controlled, so that the optical spot condensed by the object lens 9 becomes the smallest at its focal distance in the track or record mark string formed on the recording/reproducing surface 10a of the optical disc 10.

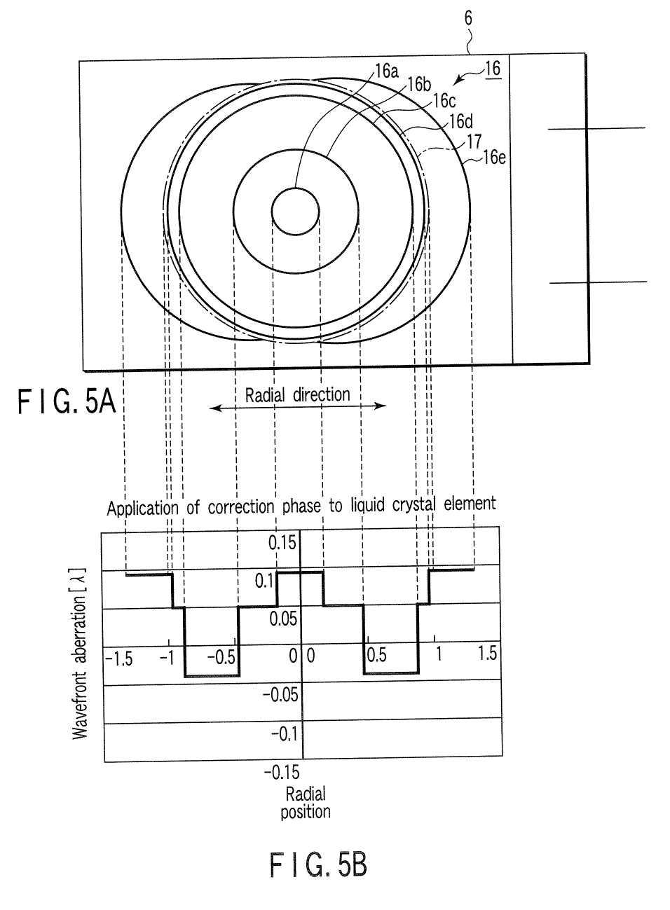

FIG. 5A shows a liquid crystal element 6 as an example of an embodiment of the invention.

A transparent electrode 16 is divided into five areas 16a, 16b, 16c, 16d and 16e. The outermost transparent electrode 16e of the liquid crystal element 6 is shaped oval by extending the outermost transparent electrode 17 (the circle indicated by a chain line) only in the radial direction when the optical axis of the object lens substantially coincides with the center of the liquid crystal element. In this case, the oval is not an ellipse, but the shape formed by pulling opposite semicircles in the separating direction like a track in an athletic field. The transparent electrodes 16a, 16b, 16c and 16d are the same shapes (the circular in this example) and positions as those when the optical axis of the object lens is not displaced from the center of the liquid crystal element.

The object lens 8 held by the actuator 9 is shifted in the radial direction of the recording/reproducing surface 10a of the optical disc 10, or the direction crossing the track or record mark string. The amount of shift is influenced most by the eccentricity of the track when the optical disc is rotated.

When the object lens 8 is shifted in the radial direction, the optical axis of the object lens 8 is displaced from the center of the transparent electrode 16 of the liquid crystal element 6. This displacement causes displacement of a pattern from a correction phase to correct aberration, and correction of aberration becomes bad compared with the state with no displacement. Particularly, in the area out of the effective area of the liquid crystal element 6, or when the optical axis of the object lens 8 substantially coincides with the center of the liquid crystal element, the area outside the outermost transparent electrode 17 is not corrected at all.

For prevention of deterioration in correction of aberration when the optical axis of the object lens 8 is displaced from the center of the transparent electrode 16 of the liquid crystal element 6, it is considerable to expand the shape of the transparent electrode 16 of the liquid crystal element 6 in the radial direction from the shape when the optical axis of the object lens 8 is not displaced from the center of the liquid crystal element 6. However, in this embodiment, only the outermost transparent electrode 16e of the transparent electrode 16 is expanded in the radial direction. The shapes of the transparent electrodes 16a, 16b, 16c and 16d are not changed, whereby correction of aberration is not deteriorated even if the optical axis of the object lens 8 is not displaced from the center of the transparent electrode 16 of the liquid crystal element 6.

For example, when the transparent electrodes 16a, 16b, 16c and 16d are expanded in the radial direction like the electrode 16e, the shape is changed from the pattern of the transparent electrode 16 initially set optimum when displacement does not occur, and the accuracy of aberration correction becomes bad even in the case that displacement does not occur. Since the object lens 8 reciprocates in the radial direction by taking the position with no displacement as a center, the object lens is mostly placed at a position where displacement does not occur. Therefore, the shapes of transparent electrodes 16a, 16b, 16c and 16d are preferably not changed.

The optical axis of the object lens 8 substantially coincides with the center of the liquid crystal element only in the outermost transparent electrode 16e, that is, the shape of the electrode 16e is expanded in the radial direction from the shape with no displacement, whereby the effect of aberration correction is ensured even if the object lens 8 is moved in the radial direction.

FIG. 5B shows a correction phase of the transparent electrode 16 of the liquid crystal element 6 in this embodiment.

The shape of the outermost transparent electrode 17 of the transparent electrode 6 set when the optical axis of the object lens 8 substantially coincides with the center of the liquid crystal element 6, is expanded in the radial direction. Only the transparent electrode 16e is expanded in the radial direction and shaped oval. In the value of the correction phase of the transparent electrode 16e, the optical axis of the object lens 8 substantially coincides with the center of the liquid crystal element 6. Namely, the value is the same as the value of the phase correction when no displacement occurs. The performance of the original aberration correction is unchanged at the position where the optical axis of the object lens 8 is not displaced from the center of the transparent electrode 16 of the liquid crystal element 6.

As described above, in this embodiment, only the outermost transparent electrode 17, among the transparent electrode 16 optimized at the position where the optical axis of the object lens 8 substantially coincides with the center of the transparent electrode 16 of the liquid crystal element 6, is expanded in the radial direction and used as the transparent electrode 16e, in the optical head 1 provided with the liquid crystal element 6 to correct aberration on the information recording surface 10a of the optical disc 10. Therefore, aberration can be corrected even if the object lens 8 is shifted in the radial direction, and aberration can be corrected with no deterioration at the position where the object lens 8 is not shifted.

In particular, a transparent electrode 102 of a liquid crystal element 101 shown in FIGS. 1A and 1B is divided into five concentric circles (102a, 102b, 102c, 102d and 102e). A liquid crystal element is an element, which corrects aberration by changing the optical path length of a laser beam by changing the refractive index of a laser beam passing through a liquid crystal. The diffractive index is changed by applying a voltage to the liquid crystal inside the liquid crystal element through a transparent electrode, and changing the orientation of the liquid crystal.

It is assumed that the transparent electrode 102 corrects spherical aberration in the state that the optical axis of the object lens 8 is not displaced from the center of the liquid crystal element 6.

For example, spherical aberration is caused by variations in the thickness of a substrate of an optical disc (the distance from the outer surface of an optical disc to a recording/reproducing surface). As the phase advances and delays according to the distance of a laser beam passing through an object lens from the optical axis of the object lens, and the advance/delay state appears concentrically with the optical axis as spherical aberration. As a transparent electrode is divided according to the distribution form of the phase changes, the transparent electrode 102 is divided concentric circles. The transparent electrode 102 assumes correction of the spherical aberration in the state that the optical axis of the object lens is not displaced from the center of the liquid crystal element.

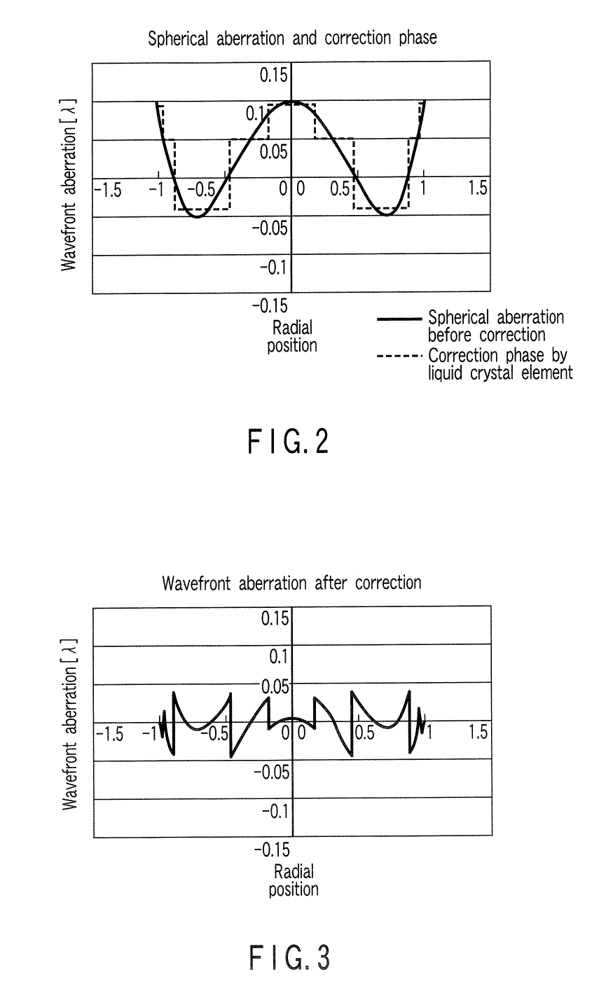

FIG. 4 shows a transparent electrode when the correction phase in FIG. 2 is applied to the liquid crystal element 101. The transparent electrode 102 of the liquid crystal element 101 is divided into five concentric circles (102a, 102b, 102c, 102d and 102e).

FIG. 2 shows a relationship between spherical aberration and correction phase.

Assuming that a numerical aperture of an object lens is NA, a diffractive index of a disc is n, and a thickness error of a disc substrate is d, spherical aberration W is obtained by
W={(n²−1)/8n³}×(NA)⁴×d (1).

This is graphically shown as the curve indicated by a solid line in FIG. 2. The solid line indicates the spherical aberration before correction. Maximum and minimum at the radial position indicate the effective areas of a laser beam. In FIG. 2, the aberration is the maximum at the center of the optical axis and the periphery. It is ideal to make the aberration zero. For this purpose, it is necessary to divide the transparent electrode 102 as finely as possible to approximate to the curve (solid line) indicating the largeness of spherical aberration.

However, this makes the wiring and driver complex, and requires high cost. Therefore, the transparent electrode 102 is desirably divided into small numbers, actually several numbers. In FIG. 2, the effective area is divided into five as a pattern of correction phase, as indicated by a broken line. Correction is made by subtracting the correction value indicated by the broken line from the value indicated by the solid line.

FIG. 3 shows the largeness of aberration after correction.

As seen from FIG. 3, the aberration after correction is the state that the correction phase (broken line) by the liquid crystal element 101 is subtracted from the spherical aberration (solid line) before correction in FIG. 2.

It is seen from FIG. 3 that the aberration at the center of the optical axis and the periphery becomes small.

It is recognized from FIG. 3 that the aberration at the center of the optical axis is particularly suppressed.

As explained hereinbefore, by using the liquid crystal element of the invention for correcting spherical aberration and comma aberration, aberration can be corrected even if the optical axis of an object lens is displaced from the liquid crystal element. Further, by using the liquid crystal element having the same pattern, the influence of correction can be prevented even if the optical axis of an object lens is not displaced from the liquid crystal element.

This can simplify a pattern of arranging light-detecting areas of a photodetector for extracting a signal from a laser beam reflected on an optical disc according to the kinds and standards of an optical disc.

Therefore, an optical head unit and an optical disc apparatus with stable characteristics can be obtained at low cost.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head unit comprising:
an object lens which condenses a laser bam emitted from a semiconductor laser toward an optical disc, and receives a return laser beam reflected from the optical disc; and
a liquid crystal element which is provided on an optical path between the semiconductor laser and the object lens, and has circular transparent electrodes provided corresponding to a shape of distribution of aberration, to correct aberration on an information recording surface of the optical disc,
wherein the transparent electrode at the center of the liquid crystal element has a shape corresponding to the distribution of aberration when the optical axis of the object lens substantially coincides with the center of the liquid crystal element, and the outermost transparent electrode of the liquid crystal element includes a shape enlarged in the radial direction from a shape corresponding to the distribution of aberration when the optical axis of the object lens substantially coincides with the center of the liquid crystal element, to correct aberration even if the optical axis of the object lens is displaced from the center of the liquid crystal element.

2. The optical head unit according to claim 1, wherein the liquid crystal element has a shape corresponding to the distribution of aberration when the optical axis of the object lens substantially coincides with the center of the liquid crystal element, and the outermost transparent electrode of the liquid crystal element is shaped like an ellipse extended in the radial direction from a shape corresponding to the distribution of aberration when the optical axis of the object lens substantially coincides with the center of the liquid crystal element, to correct aberration even if the optical axis of the object lens is displaced from the center of the liquid crystal element.

3. An optical disc apparatus comprising:
an optical head unit including an object lens which condenses a laser beam emitted from a semiconductor laser toward an optical disc, and receives a return laser beam reflected from the optical disc;
a liquid crystal element which is provided on an optical path between the semiconductor laser and the object lens, provided corresponding to a shape of distribution of aberration, and has a shape corresponding to the distribution of aberration when the optical axis of the object lens substantially coincides with the center of the liquid crystal element, and the outermost transparent electrode of the liquid crystal element having circular transparent electrodes including a shape enlarged in the radial direction from a shape corresponding to the distribution of aberration when the optical axis of the object lens substantially coincides with the center of the liquid crystal element, to correct aberration even if the optical axis of the object lens is displaced from the center of the liquid crystal element; and
an arithmetic circuit which processes a reproducing signal of information of the optical disc from an output of a photodetector of the optical head unit.

4. An optical disc apparatus according to claim 3, wherein the liquid crystal element of the optical head unit including a shape corresponding to distribution of aberration when the optical axis of the object lens substantially coincides with the center of the liquid crystal element, and the outermost transparent electrode of the liquid crystal element having a shape like an ellipse extended in the radial direction from a shape corresponding to the distribution of aberration when the optical axis of the object lens substantially coincides with the center of the liquid crystal element, to correct aberration even if the optical axis of the object lens is displaced from the center of the liquid crystal element.

5. An optical head unit comprising:
an object lens which captures an optical beam reflected on a recording surface of a recording medium;
a wavefront conversion element (liquid crystal element) which divides a wavefront of a reflected beam passed through the object lens and reflected by the recording medium into several wavefronts, and corrects an aberration component superposed on the reflected beam depending on variations in the thickness of a transparent support layer of the recording medium and/or the inclination of a recording surface of the recording medium, for each divided wavefront; and
a photodetector which detects the reflected beam passing through the wavefront conversion element, and outputs an output signal corresponding to the light intensity.

6. The optical head unit according to claim 5, wherein the wavefront conversion element includes several different thickness areas divided along the radial direction of the recording medium.

7. The optical head unit according to claim 6, wherein two outermost areas, among the different thickness areas divided along the radial direction of the recording medium of the wavefront conversion element, are shaped like an ellipse extended in the radial direction.
